(19) United States
(12) Patent Application Publication
(10) Pub. No.: US 2022/0287320 A1
(43) Pub. Date: Sep. 15, 2022

(54) CHEESE ANALOGUE COMPOSITIONS

(71) Applicant: EARTH ISLAND, Chatsworth, CA (US)

(72) Inventor: Chandrani Atapattu, Chatsworth, CA (US)

(21) Appl. No.: 17/694,531

(22) Filed: Mar. 14, 2022

Related U.S. Application Data
(60) Provisional application No. 63/160,679, filed on Mar. 12, 2021.

(51) Int. Cl. A23C 20/02

(52) U.S. Cl. CPC A23C 20/02

(57) ABSTRACT

A cheese analogue (or substitute) composition includes a fat source, a starch source and/or a protein source, a leavening agent, and a water source. A method of making the cheese analogue (or substitute) composition includes mixing the fat source, the dry ingredient mixture, the leavening agent, and the water source to form a composition mixture, and heating the composition mixture to form curds.

### CROSS-REFERENCE TO RELATED APPLICATION(S)

This application claims priority to and the benefit of U.S. Provisional Application No. 63/160,679, filed Mar. 12, 2021 and titled CHEESE ANALOGUE COMPOSITIONS, the entire content of which is incorporated herein by reference.

### BACKGROUND

Rising interest in vegetarian and vegan diets has led to an increase in demand for dairy alternatives. However, cheese is one dairy product that is difficult to imitate using non-dairy components. Natural cheese (i.e., cheese made by traditional methods using conventional dairy components) has complex physical and functional characteristics—such as melt, firmness, and stretch—that are particularly difficult to reproduce without the use of dairy. Additionally, natural cheeses have unique texture and flavor profiles that are also very difficult to replicate without certain dairy components. As a result, existing cheese substitutes or analogues typically include certain dairy proteins (e.g., casein and/or whey protein) in order to mimic the melt and stretch properties, as well as the nutritional profile of natural cheese. Indeed, the role these dairy proteins play in the structure and function of cheese analogues have proven to be extremely difficult to replicate or substitute in cheese substitutes or cheese analogs with non-dairy components. Existing cheese analogues, therefore, continue to use casein protein (and sometimes whey protein). But since the demand for vegan cheese alternatives is rising, these dairy-based cheese substitutes or analogues have limited use. In particular, as these dairy-based cheese alternatives are not dairy-free, they are not suitable for the popular vegan diet. Additionally, while such cheese substitute or analogue compositions may be suitable for a vegetarian diet, they often fall short of satisfactorily imitating the physical and functional characteristics of natural cheese in certain applications.

### SUMMARY

According to embodiments of the present disclosure, a cheese analogue or cheese substitute composition comprises a fat source, a leavening agent, a water source, and a dry ingredient mixture comprising a starch source and/or a protein source.

In some embodiments, the cheese analogue or cheese substitute composition may further comprise one or more additives. The one or more additives may include one or more acidulants, flavor additives, emulsifying salts, pH adjusters, colorants, dietary additives, and/or humectants. In some embodiments, the dry ingredient mixture may include the one or more additives.

According to embodiments, the leavening agent may include a chemical leavening agent. The chemical leavening agent may include sodium bicarbonate. And in some embodiments, the chemical leavening agent may include baking soda and/or baking powder. In some embodiments, the baking soda and/or the baking powder may be encapsulated. And in some embodiments, the leavening agent may be present in the composition in an amount of greater than 0 wt % to about 5 wt % based on a total weight of the composition.

In some embodiments, the fat source may include a plant-based fat source, and/or the protein source may include a plant-based protein source, and/or the starch source may include a plant-based starch source. And in some embodiments, the cheese analogue or cheese substitute composition may be vegetarian or vegan.

According to some embodiments, a method of making the cheese analogue or cheese substitute composition includes mixing the fat source, the dry ingredient mixture, the leavening agent, and the water source to form a composition mixture, and heating the composition mixture to form curds. The heating the composition mixture may include heating the composition mixture to a temperature of about 150° F. to about 190° F. And in some embodiments, the heating the composition mixture may include a first heating of the composition mixture to a temperature of about 150° F. to 155° F., a second heating of the composition mixture to a temperature of about 160° F. to about 180° F., and a third heating of the composition mixture to a temperature of about 190° F.

In some embodiments, the mixing the fat source, the dry ingredient mixture, the leavening agent, and the water source to form a composition mixture may include mixing the water source and the fat source to form a first precursor mixture, and heating the first precursor mixture. The mixing may further include adding the dry ingredient mixture to the first precursor mixture to form a second precursor mixture, and heating the second precursor mixture. And the mixing may further include adding the leavening agent to the second precursor mixture to form the composition mixture.

According to some embodiments, the mixing the fat source, the dry ingredient mixture, the leavening agent, and the water source to form a composition mixture may include mixing the dry ingredient mixture with the fat source to form a first precursor mixture, adding the water source to the first precursor mixture to form a second precursor mixture, and heating the second precursor mixture. And the mixing may further include adding the leavening agent to the second precursor mixture to form the composition mixture.

In some embodiments, the mixing the fat source, the dry ingredient mixture, the leavening agent, and the water source to form a composition mixture may include mixing the water source and the fat source to form a first precursor mixture, and heating the first precursor mixture. The mixing may further include adding the dry ingredient mixture and the leavening agent to the first precursor mixture to form the composition mixture.

And in some embodiments, the mixing the fat source, the dry ingredient mixture, the leavening agent, and the water source to form a composition mixture may include mixing the dry ingredient mixture and the leavening agent with the fat source to form a first precursor mixture, and adding the water source to the first precursor mixture to form the composition mixture.

According to some embodiments, the mixing may include mixing the water source and the dry ingredient to form a first precursor mixture, and heating the first precursor mixture. The mixing may further include adding the leavening agent to the first precursor mixture to form a second precursor mixture, and adding the fat source to the second precursor mixture. The mixing may further include heating the second precursor mixture to form the composition mixture.

### BRIEF DESCRIPTION OF THE DRAWINGS

These and other features of embodiments of the present disclosure can be better understood by reference to the following detailed description when considered in conjunction with the following drawings in which:

FIG. 1A is a photograph of pizza 1 prior to baking, including the frozen cheese substitute composition according to Example 3 coated with cellulose,

FIG. 1B is a photograph of pizza 1 from FIG. 1A after baking from frozen at 450° F. for 11-12 minutes;

FIG. 2A is a photograph of pizza 2 prior to baking, including a first half topped with the frozen cheese substitute composition according to Example 3 (without an anti-caking agent), a second half topped with the refrigerated cheese substitute composition according to Example 3 (coated with an anti-caking agent);

FIG. 2B is a photograph of pizza 2 from FIG. 2A after baking at 450° F. for 11-12 minutes;

FIG. 3A is a photograph of pizza 3 prior to baking, including a first half topped with the frozen cheese substitute composition according to Example 3 (without an anti-caking agent), and a second half topped with the refrigerated cheese substitute composition according to Example 3 (coated with an anti-caking agent);

FIG. 3B is a photograph of pizza 3 from FIG. 3A after baking at 750° F. for 6 minutes;

FIG. 4 is a photograph of pizza 4 after baking at 450° F. for 11-12 minutes, where pizza 4 includes a first half topped with the cheddar cheese substitute composition according to Example 1, and a second half topped with a natural cheddar cheese;

FIG. 5 is a photograph of pizza 5 after baking at 450° F. for 11-12 minutes, where pizza 5 includes a first half topped with the mozzarella cheese substitute composition according to Example 3, and a second half topped with a natural mozzarella cheese;

FIG. 6 is a photograph of pizza 6 after baking at 450° F. for 11-12 minutes, where pizza 6 includes a first half topped with the mozzarella cheese substitute composition according to Example 3 (with a leavening agent), and a second half topped with the mozzarella cheese substitute composition according to Example 3 (but without the leavening agent); and

FIG. 7 is a photograph of pizza 7 after baking at 450° F. for 11-12 minutes, where pizza 7 includes a first half topped with the mozzarella cheese substitute composition according to Example 3 (but without the leavening agent), and a second half topped with natural mozzarella cheese.

### DETAILED DESCRIPTION

Cheese analogues (or cheese substitutes) are generally understood to be products that look like and perform like traditional dairy cheeses. However, the components of cheese analogues and cheese substitutes can vary, in some instances including certain dairy ingredients, and in other instances being generally free of any dairy ingredients. Indeed, in cheese analogues (or cheese substitutes) that are marketed or formulated as vegan, the components are generally free of any dairy ingredients. These (often, but not always, excluded) dairy ingredients typically include dairy fats and/or dairy proteins, and other dairy micronutrients, such as lactose, dairy peptides, dairy minerals, etc.

Cheese analogues (or substitutes) can be made using a variety of different dry ingredients in combination with a liquid phase. Non-limiting examples of some of the dry ingredients include starches, proteins, emulsifying salts, salt, sugars, acidulants, humectants, flavoring agents, coloring agents, etc. The selected combination of dry ingredients is incorporated into a liquid phase to form the cheese analogue (or substitute), which liquid phase typically includes fat and water. Because the specific dry ingredients and liquid phase are selected to create a cheese analogue (or substitute) that mimics one or more attributes or properties of the corresponding dairy cheese (e.g., cheddar, mozzarella, etc.), these ingredients (or components) may vary from analogue to analogue. For example, the combination of components used to mimic a cheddar dairy cheese may differ from those used to mimic a mozzarella cheese, and so forth.

However, according to embodiments of the present disclosure, cheese analogues (or cheese substitutes) are improved by the addition of a leavening agent. Indeed, the addition of the leavening agent according to embodiments of the present disclosure results in cheese analogues (or substitutes) having improved properties and performance, e.g., better imitation of the feel and appearance of natural (or dairy) cheese, and significantly improved melt characteristics.

According to embodiments of the present disclosure, a cheese analogue (or cheese substitute) composition includes a fat source, a starch source and/or a protein source, a leavening agent, and a water source. The cheese analogue composition may further include one or more additives, non-limiting examples of which include acidulants, flavor additives, emulsifying salts, pH adjusters, colorants, dietary additives (e.g., fiber) and/or humectants. Throughout this disclosure, various ingredients of the cheese analogue composition are described. It is understood that, even if not specifically noted, each of the ingredients are food-safe products that are suitable for use in food for human consumption.

As used herein, the terms “cheese” and “natural cheese” refer to conventional dairy-based cheese products. Also, as used herein, the terms “cheese substitute,” “cheese analogue” and like terms are used in their art recognized sense to refer to compositions that can simulate, replace, or substitute natural cheese in various applications, but that are not, in fact, natural cheeses. For example, a cheese substitute (or cheese analogue) composition according to embodiments of the present disclosure includes structural, functional and culinary properties that emulate natural cheese. Specifically, a cheese substitute according to embodiments of the present disclosure emulate the meltability, stretchability, shreddability, firmness, texture and flavor properties of natural cheese. Indeed, according to embodiments of the present disclosure, the cheese substitute (or cheese analogue) composition emulates natural cheese such that it can be used as a substitute for natural cheese in a 1:1 ratio by weight or volume in various culinary applications.

According to some embodiments, the cheese analogue (or cheese substitute) composition may include certain dairy components (e.g., casein or whey protein) as in conventional cheese analogue compositions. However, in some embodiments of the present disclosure, the cheese analogue (or cheese substitute) composition may be substantially dairy-free. As used herein, the term “substantially” is used as a term of approximation, and not as a term of degree, and is intended to account for the possibility of incidental impurities in the listed component. For example, the term “substantially dairy-free” refers to a composition that does not include added dairy or dairy components (e.g., casein or whey protein, or any other dairy component), and refers to the inclusion of any dairy or dairy components in the composition only as incidental impurities in negligible amounts that do not contribute to the function or properties of the composition. In contrast, a composition that is “dairy-free” or “completely dairy-free” contains no measurable amount of dairy or dairy components. Similarly, a composition that is “substantially free” of a listed ingredient or component refers to a composition that does not include added or intentionally added amounts of the listed ingredient or components, and includes the listed ingredient or component only in a negligible amount or as an incidental impurity. Conversely, a composition that is “free,” or “completely free,” of a listed ingredient or component contains no measurable amount of the listed ingredient or component.

As noted above, in some embodiments of the present disclosure, the cheese substitute composition includes a fat (or lipid) source, a starch source and/or a protein source, a leavening agent, and water. Any suitable starch source, protein source, and fat source may be used, including dairy-based sources.

In some embodiments, however, the starch source, fat source and protein source may be plant-based, or based on components that are not derived from animal or animal byproduct sources. As used herein, the term “plant-based” refers to the vegan properties of the components, and indicates that the components are not sourced from or derived from an animal or animal product. As such, the components that are “plant-based” are substantially free, or completely free (as those terms are defined herein, above) of any animal products or animal byproducts. What constitutes an animal product or byproduct is well known in this field, and to those following a vegetarian or vegan diet. In particular, the term “animal product” refers to any animal parts, animal byproducts, or products produced by an animal. Some examples of materials that would be considered “animal products” include those parts of the animal that are consumable or typically prepared for consumption by humans (including, e.g., fat, flesh, blood, etc.). Products produced by an animal are also considered “animal products” as used herein, and refer to the products produced by an animal without slaughtering the animal, (e.g., milk, eggs, honey, etc.). “Animal byproducts” are products that are typically not consumable by themselves but are the byproducts of slaughtering animals for consumption, e.g., bones, carcasses etc. However, animal byproducts are often processed into human consumable foodstuffs, some well-known examples of which include gelatin, casein, whey, rennet, etc. As used herein, these processed animal byproducts (e.g., gelatin, casein, whey, rennet, etc.) are encompassed by the term “animal byproducts.” As described herein, “plant-based” components or ingredients are substantially free (or in some embodiments, completely free) of such animal products and byproducts.

In some embodiments, however, the cheese analogue (or cheese substitute) composition can be suitable for a vegan diet and/or a vegetarian diet. For example, in embodiments in which the composition is suitable for a vegan diet, the composition may include primarily plant-based components such that the composition contains substantially no animal products, animal byproducts, or substantially no components derived from these animal sources. In some embodiments, however, the composition is suitable for a vegetarian diet, and is not necessarily suitable for a vegan diet. In these embodiments, for example, the composition may remain substantially free of animal meat (e.g., fat, flesh, blood, etc.), but may contain animal byproducts (e.g., gelatin, casein, whey, etc.) and/or components sourced from animals (including, e.g., milk, etc.).

The starch source in the cheese analogue (or cheese substitute) composition may be any suitable starch source. For example, in some embodiments, the starch source may be a component that is not sourced from an animal, animal product and/or animal byproduct. Indeed, in some embodiments, the starch source may be any suitable plant-based starch or plant-based modified starch. Some nonlimiting examples of suitable starches, modified starches and/or lipids (or fats) include those derived from vegetables and legumes (e.g., peas, beans (including garbanzo, fava, pinto, kidney, lima beans, mung beans, etc.), soy, lentils) and sprouted beans (including garbanzo (or chick pea), fava, pinto, kidney, lima beans, mung beans, etc.), soy, lentils), seeds (e.g., chia, lupine), grains and sprouted grains (e.g., oats, corn, rice, wheat, including gluten, quinoa, amaranth, buckwheat, millet), tubers and roots (e.g., potatoes, sweet potatoes), fruits (e.g., tomatoes, sun-dried tomatoes, cranberries, pumpkins), hemp, nuts (e.g., coconut, almond, cashew, pistachio), algae (e.g., chlorella, spirulina), seaweed, isolated starches (e.g., corn starch, arrowroot starch, tapioca starch, etc.), etc. In some embodiments, for example, the starch source may include a potato starch, a modified potato starch and/or a tapioca starch. It is understood, also, that any combination of different starch sources may be used.

As used herein, the term “modified starch” is used in its art-recognized sense to refer to starches that have been physically, chemically or enzymatically modified to alter the property of the unmodified starch. Modifications may be made to starches for a variety of different reasons, e.g., to increase stability against different conditions (including, but not limited to heat, acid, shear, time, cooling, or freezing), to alter texture or viscosity, to modify gelatinization time, to increase visco-stability, etc. The modifications needed to make such adjustments to the starches are known, and those of ordinary skill in the art would be capable of selecting an appropriate modified starch based on the function desired to be accomplished by the modification.

In some embodiments, the starch source may be present in the composition in an amount of about 0 wt % to about 35 wt %, or in a positive amount (i.e., greater than 0 wt %) to about 35 wt % based on the total weight of the cheese analogue composition. In some embodiments, for example, the starch source may be present in the composition in an amount of about 1 wt % to about 30 wt %, for example about 1 wt % to about 28 wt % based on the total weight of the composition. In some embodiments, for example, the starch source may be present in the composition in an amount of about 10 wt % to about 30 wt %, about 15 wt % to about 30 wt %, or about 18 wt % to about 28 wt % based on the total weight of the composition. For example, in some embodiments, the starch source may be present in the composition in an amount of about 12 wt %, 13 wt %, 14 wt %, 15 wt %, 16 wt %, 17 wt %, 18 wt %, 19 wt %, 20 wt %, 21 wt %, 22 wt %, 23 wt % or 24 wt % based on the total weight of the composition.

The protein source is not particularly limited, and may include any suitable protein, including dairy sources (e.g., casein, whey, etc.). In some embodiments, however, the protein source may include a component that is not sourced from an animal, animal product and/or animal by-product. Indeed, the protein may be any suitable plant-based protein, and may be provided in any suitable form, including as a concentrate or isolate, in liquid form, or as a particulate powder. Some nonlimiting examples of suitable protein sources include those derived from vegetables and legumes (e.g., spinach, Brussels sprouts, peas, beans (including garbanzo (or chick pea), fava, pinto, kidney, lima beans, etc.), soy, lentils), seeds (e.g., chia, lupine), grains (e.g., corn, rice, wheat, including gluten, quinoa, amaranth, buckwheat, millet), tubers and roots (e.g., potatoes, sweet potatoes), fruits (e.g., tomatoes, sun-dried tomatoes, cranberries, pumpkins), hemp, nuts (e.g., almond, cashew, pistachio), coconut, algae (e.g., chlorella, spirulina), seaweed, etc. It is understood, also, that any combination of different protein sources may be used.

The protein source may be present in the composition in any suitable amount. In some embodiments, for example, the protein additive(s) may be present in the composition in an amount of 0 wt % (i.e., protein is omitted) to about 10 wt % based on the total weight of the composition, or in a positive amount of greater than 0 wt % to about 10 wt %. For example, in some embodiments, the protein additive(s) may be present in an amount of 0 wt % (i.e., protein is omitted) to about 8 wt %, 0 wt % (i.e., protein is omitted) to about 7 wt %, 0 wt % (i.e., protein is omitted) to about 4 wt %, or 0 wt % (i.e., protein is omitted) to about 2 wt %. And in some embodiments, the protein additive(s) may be present in an amount of about 0.1 wt % to about 10 wt %, about 0.1 wt % to about 8 wt %, about 0.1 wt % to about 0.7 wt %, about 0.1 to about 4 wt %, about 0.1 wt % to about 2 wt %, about 0.4 wt % to about 10 wt %, about 0.4 wt % to about 8 wt %, about 0.4 wt % to about 7 wt %, about 0.4 wt % to about 4 wt %, or about 0.4 wt % to about 2 wt % based on the total weight of the composition. In some embodiments, the protein additive(s) may be present in the composition in an amount of about 0 wt % (i.e., proteins are omitted), 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt % or 7 wt % based on the total weight of the composition.

According to embodiments of the present disclosure, the protein and/or starch source (which may contain either or both of the protein source and the starch source described herein) may be provided as a dry ingredient mixture or component. For example, the dry ingredient mixture or component may include the protein source and/or the starch source in dry or powder form. As such, in some embodiments, the cheese analog (or substitute) composition may include the dry ingredient mixture (or component), the fat (or lipid) source, the leavening agent, and the water source. And in some embodiments, the dry ingredient mixture may further include the additives discussed below.

The fat (or lipid) source in the cheese analogue (or cheese substitute) composition is also not particularly limited, and may be any suitable fat (or lipid) source, including diary sources. In some embodiments, however, the fat (or lipid) source may be a component that is not sourced from an animal, animal product and/or animal byproduct. Indeed, in some embodiments, the fat (or lipid) source may be any suitable plant-based fat (or lipid), and may include a solid fat (or lipid) source and/or a liquid fat (or lipid) source (e.g., an oil).

In some embodiments, the fat (or lipid) source includes a solid fat (or lipid), i.e., in some embodiments, the lipid (or fat) source includes a saturated fat. This contrasts with liquid fat (or lipid) sources (e.g., oils), which are in liquid form, and include an unsaturated fat. Any saturated fat source (or solid fat (or lipid) source) may be used as the solid fat (or lipid) source, without limitation. In some embodiments, for example, the solid fat (or lipid) source may include any vegetable-based saturated fat (i.e., any vegetable-based fat that is solid at room temperature (i.e., 23-25° C.)). Non-limiting examples of suitable such solid fats include vegetable shortening, coconut oil, palm oil, palm kernel oil, cocoa butter, and margarine. In some embodiments, for example, the fat (or lipid) source includes coconut oil.

In some embodiments, the fat (or lipid) source may include a liquid fat (or lipid) source, e.g., an oil (or unsaturated fat). The oil (or liquid fat source) in the composition is also not particularly limited, and may be any suitable food-safe oil. For example, in some embodiments, the oil may be a component that is not sourced from an animal, animal product and/or animal byproduct. Indeed, in some embodiments, the oil may be any suitable plant-based oil.

In some embodiments, as noted above, the oil includes a liquid fat (or lipid), i.e., in some embodiments, the oil includes an unsaturated fat. This contrasts with the solid fat (or lipid), which is a fat in solid form, i.e., a saturated fat. Any unsaturated fat source (or liquid fat) may be used as the liquid fat (or lipid) source (i.e., the oil), without limitation. In some embodiments, however, the oil (or liquid fat source) may include any vegetable-based oil or unsaturated fat (i.e., any vegetable-based fat that is liquid at room temperature (i.e., 23-25° C.)). Non-limiting examples of suitable such oils (or liquid fat sources) include vegetable oils, nut oils, seed oils, etc., such as, but not limited to vegetable oil, canola oil, corn oil, grapeseed oil, sunflower oil, olive oil, safflower oil, peanut oil, avocado oil, soybean oil, etc. In some embodiments, for example, the oil (or liquid fat source) includes a neutral-tasting oil such that the oil does not adversely affect the flavor of the cheese analogue composition. Non-limiting examples of suitable such neutral-tasting oils include vegetable oil, canola oil, grapeseed oil, safflower oil, corn oil, sunflower oil, soybean oil, peanut oil, etc.

In some embodiments, the fat (or lipid) source (whether solid, liquid or a combination of the two) may be present in the composition in an amount of about 0 wt % to about 35 wt %, or in a positive amount (i.e., greater than 0 wt %) to about 35 wt % based on the total weight of the substantially dairy-free cheese analogue composition. In some embodiments, for example, the lipid (or fat) source may be present in the composition in an amount of about 1 wt % to about 30 wt %, for example about 5 wt % to about 30 wt % based on the total weight of the composition. In some embodiments, for example, the fat (or lipid) source may be present in the composition in an amount of about 5 wt % to about 35 wt %, about 8 wt % to about 32 wt %, about 12 wt % to about 32 wt %, or about 10 wt % to about 30 wt % based on the total weight of the composition. For example, in some embodiments, the fat (or lipid) source may be present in the composition in an amount of about 13 wt %, 15 wt %, 18 wt %, 20 wt %, 23% or 25% based on the total weight of the composition.

According to some embodiments, as noted above, the fat (or lipid) source may include a combination of a solid fat source and a liquid fat source (i.e., an oil). Any combination of suitable such solid and liquid fat sources can be used, without limitation. The amount of each of the solid and liquid fat sources is not particularly limited, and may be any suitable amount, including, for example, a greater amount of solid fat and a lesser amount of liquid fat, and vice versa. In some embodiments, for example, the sum total amount of solid fat and liquid fat can fall within the ranges described above for the fat (or lipid) source as a whole. However, in some embodiments, the liquid fat (or lipid) source (i.e., oil) may be present in an amount of 0 wt % (oil is omitted) to about 30 wt % based on the total weight of the cheese analogue composition, with the solid fat either being omitted or making up the remainder of the above described range. In some embodiments, for example, the oil may be present in the composition in an amount of about 0.5 wt % to about 28 wt %, for example about 0.5 wt % to about 18 wt % based on the total weight of the composition, with the solid fat either being omitted or making up the remainder of the above described range. In some embodiments, for example, the oil may be present in the composition in an amount of about 1 wt % to about 20 wt %, about 1 wt % to about 15 wt %, about 1 wt % to about 10 wt %, or about 1 wt % to about 6 wt % based on the total weight of the composition, with the solid fat either being omitted or making up the remainder of the above described range. For example, in some embodiments, the oil may be present in the composition in an amount of about 0.5 wt %, 1 wt %, 1.5 wt %, 2 wt %, 2.5 wt %, 3 wt %, 3.5 wt %, 4 wt %, 4.5 wt % or 5 wt % based on the total weight of the composition, with the solid fat either being omitted or making up the remainder of the above described range.

The leavening agent in the cheese analogue (or cheese substitute) composition is not particularly limited, and may be any suitable leavening agent. As would be understood by those of ordinary skill in the art, a leavening agent is a component that produces gas within a composition (e.g., a dough or batter) upon exposure to (or reaction with) another component or condition (e.g., an acid or heat). There are generally three different types of leavening agents: 1) biological leavening agents (e.g., yeast); 2) chemical leavening agents (e.g., sodium bicarbonate); and 3) steam. Yeast (a biological leavening agent) produces the gas leading to leavening by fermentation. Chemical leavening agents produce the leavening gas by the reaction of acids and bases, which reaction is activated by the addition or application of water and/or heat. And steam produces the leavening gas by the vaporization of water in the composition upon exposure to sufficient heat.

According to embodiments of the present disclosure, the leavening agent includes a chemical leavening agent. Non-limiting examples of suitable chemical leavening agents include any suitable food-safe base combined with a suitable and compatible food-safe acid. For example, in some embodiments, the food-safe base may include sodium bicarbonate. In such embodiments, sodium bicarbonate (serving as the base) produces the gas leading to leavening upon reaction with one or more acids. Any suitable acid may be used in combination with the sodium bicarbonate, some non-limiting examples of which include monocalcium phosphate monohydrate, anhydrous monocalcium phosphate, sodium acid pyrophosphate, sodium aluminum sulfate, sodium aluminum phosphate, sodium acid tartrate, dicalcium phosphate dihydrate, glucono-delta-lactone, potassium bitartrate (i.e., cream of tartar), and the like.

According to embodiments of the present disclosure, however, the leavening agent reacts with the starch source (and other components of the composition, e.g., proteins (when present)) to produce surprisingly superior physical and functional properties emulating natural cheese. For example, according to embodiments of the present disclosure, the inclusion of a leavening agent (e.g., sodium bicarbonate in combination with a suitable acid) produces cheese analogue (or cheese substitute) compositions having improved melt properties that, when compared to conventional cheese analogue compositions, better mimic the melting characteristics of natural cheese, particularly when melted on pizza.

In embodiments in which the leavening agent includes sodium bicarbonate, the sodium bicarbonate may be provided in any suitable form. As understood by those of ordinary skill in the art, sodium bicarbonate is typically available as either baking soda or baking powder. The main difference between these products is the presence of a dry acid. Specifically, while baking soda includes raw sodium bicarbonate (which is alkaline), baking powder includes a dry acid (or a combination of dry acids) together with the sodium bicarbonate. The acid provided in the baking powder is not particularly limited, and can vary between different suppliers, but any commercially available, food-safe baking powder may be used in the presently disclosed compositions. According to embodiments of the present disclosure, the sodium bicarbonate may be provided by either baking soda or baking powder, or by a combination of the two.

In some embodiments, the chemical leavening agent (e.g., the baking soda or the baking powder) may be encapsulated. As would be understood by those of ordinary skill in the art, encapsulated sodium bicarbonate includes sodium bicarbonate that is encapsulated, typically by a hydrogenated fat, such as (but not limited to) cottonseed oil, palm oil, glycerides (e.g., mono- or di-glycerides) or soybean oil. This encapsulation prevents dissolution of the sodium bicarbonate until the composition is heated (e.g., to melt the cheese substitute composition). Any suitable, food-safe encapsulated sodium bicarbonate may be used in the presently disclosed compositions. Indeed, any commercially available, food-safe encapsulated baking soda or encapsulated baking powder may be used. Additionally, as noted generally above, the sodium bicarbonate may be present in the composition in any one or more suitable forms, e.g., as baking soda, baking powder, encapsulated baking soda, encapsulated baking powder, or any mixture thereof.

In some embodiments, the leavening agent (e.g., sodium bicarbonate in any form) may be present in the composition in a positive amount (i.e., greater than 0 wt %) to about 5 wt % based on the total weight of the substantially dairy-free cheese analogue composition. More specifically, the sodium bicarbonate in any form (i.e., whether provided as baking soda, baking powder, encapsulated baking soda, and/or encapsulated baking powder) may be present in the composition within the same range, i.e., in a positive amount (i.e., greater than 0 wt %) to about 5 wt % based on the total weight of the substantially dairy-free cheese analogue composition. In some embodiments, for example, the sodium bicarbonate (in any form or mixture of forms) may be present in the composition in an amount of about 0.1 wt % to about 5 wt %, for example about 0.1 wt % to about 3 wt % based on the total weight of the composition. In some embodiments, for example, the sodium bicarbonate (in any form or mixture of forms) may be present in the composition in an amount of about 0.1 wt % to about 4 wt %, about 0.1 wt % to about 2 wt %, about 0.1 wt % to about 1.5 wt %, or about 0.1 wt % to about 1.2 wt % based on the total weight of the composition. For example, in some embodiments, the sodium bicarbonate (in any form or mixture of forms) may be present in the composition in an amount of about 0.1 wt %, 0.25 wt %, 0.5 wt %, 0.6 wt %, 0.75 wt %, 1.0 wt %, 1.2% or 1.5% based on the total weight of the composition.

The water source is also not particularly limited, and may include any liquid that contains water, and is food-safe. Some non-limiting examples of suitable such liquids for the water source include water, milks (including, but not limited to animal milks, nut milks, plant-based milks, etc.), juice (including, but not limited to vegetable, fruit, or other plant juices), brines (including, but not limited to, fluid or liquid used to soak beans, legumes, etc.), etc. In some embodiments, for example, the water source includes water. It is understood, however, that any combination of different types of water sources can be used (e.g., a mixture of water and a milk, water and a juice, a milk and a juice, etc.). However, the water source includes at least some water, and in some embodiments, the water source is water alone.

The amount of the water source in the composition is not particularly limited, and may vary depending on the type of natural cheese intended to be imitated by the cheese substitute (or analogue) composition. For example, relatively drier cheeses (e.g., cheddar) may contain less water source than relatively moister cheeses (e.g., mozzarella). However, in some embodiments, the moisture content of the cheese substitute (or analogue) composition may be adjusted by other components (i.e., components other than water), e.g., humectants (as discussed further below).

In some embodiments, the water source may be present in the composition in an amount of about 10 wt % to about 80 wt % based on the total weight of the cheese analogue composition. In some embodiments, for example, the water source may be present in the composition in an amount of about 10 wt % to about 70 wt %, for example about 12 wt % to about 70 wt % based on the total weight of the composition. In some embodiments, for example, the water source may be present in the composition in an amount of about 10 wt % to about 60 wt %, about 10 wt % to about 50 wt %, about 20 wt % to about 70 wt %, about 20 wt % to about 60 wt %, about 20 wt % to about 50 wt %, about 30 wt % to about 70 wt %, about 30 wt % to about 60 wt %, about 30 wt % to about 50 wt %, about 40 wt % to about 70 wt %, about 40 wt % to about 60 wt %, about 40 wt % to about 50 wt %, or about 42 wt % to about 50 wt % based on the total weight of the composition. For example, in some embodiments, the water source may be present in the composition in an amount of about 35 wt %, 40 wt %, 45 wt %, 50 wt % or 55 wt % based on the total weight of the composition.

In addition to the starch source and/or protein source, fat (or lipid) source, leavening agent, and water source, in some embodiments, the cheese substitute (or analogue) composition may further, optionally include certain additives, for example, to enhance the flavor of the composition, or to adjust one or more physical or chemical properties of the composition. The additives included for these purposes are not particularly limited, and may include any suitable additive for accomplishing the desired physical or chemical modification (e.g., color, texture, pH, flavor, moisture content or retention, etc.). For example, in some embodiments, the cheese substitute (or analogue) composition may include one or more of flavorants, acidulants, emulsifying salts, pH adjusting agents, colorants, dietary additives, humectants, and/or other structural and/or functional additives.

In some embodiments, these additives may be provided in dry form, and may be separately added to the cheese analog composition, or may be part of the dry ingredient mixture discussed above in connection with the starch and/or protein source. It is also understood that when multiple different additives are included in the cheese analog composition, each individual additive may be either separately added to the composition or included in the dry ingredient mixture. For example, in some embodiments, certain of these additives (e.g., those that are provided in solid or powder form) may be included in the dry ingredient mixture while other additives (e.g., those provided in gel or liquid form) may be separately added to the composition.

Any suitable flavorants may be used, including, but not limited to, salt and other seasonings, natural flavorings, and various different cheese flavorants. Indeed, as would be understood by those of ordinary skill in the art, selection of suitable flavorants will depend on the type of cheese intended to be imitated via the cheese substitute (or analogue) composition. For example, as would be understood by those of ordinary skill in the art, cheese substitute (or analogue) compositions intended to imitate cheddar cheese will require different flavorants than compositions intended to imitate, e.g., mozzarella or American cheese. There are various commercially available flavorants on the market that are generally capable of imitating a wide variety of natural cheese flavors (e.g., cheddar, mozzarella, American, etc.). Any such commercially available flavorants, either alone or in any combination, may be used as the flavorants in the presently disclosed cheese substitute (or analogue) compositions. As such, the presently disclosed cheese substitute (or analogue) compositions may be tailored to imitate any flavor of natural cheese, without limitation. Some non-limiting examples of suitable flavorants include American cheese flavorants, salt, natural butter flavorants, melted butter flavorants, cheddar flavorants, sugar, starter distillate, and various herbs and spices (e.g., flaxseed and/or oregano, or the like).

The flavorants may be included in the cheese substitute (or analogue) composition in any suitable amount depending on the desired flavor of the composition. For example, in some embodiments the flavorants may be present in the composition (i.e., either individually or collectively as a combined total amount of all flavorants) in an amount of 0 wt % to about 5 wt %, or in a positive amount (i.e., greater than 0 wt %) to about 5 wt % based on the total weight of the composition. In some embodiments, for example, the flavorants may be present (i.e., either individually or collectively) in the composition in an amount of about 0.01 wt % to about 5 wt %, about 0.03 wt % to about 5 wt %, about 0.1 wt % to about 5 wt %, about 0.3 wt % to about 5 wt %, about 0.4 wt % to about 5 wt %, or about 0.1 wt % to about 3 wt %. In some embodiments, for example, the flavorants may be present collectively in the composition in an amount of about 0.1 wt % to about 5 wt %, about 0.3 wt % to about 5 wt %, about 0.1 wt % to about 4 wt %, or about 0.1 wt % to about 3 wt %. In some embodiments, for example, the flavorants may be present collectively in the composition in an amount of about 1 wt %, 1.5 wt %, 2 wt %, 2.5 wt %, 3 wt %, 2.5 wt %, or 4 wt % based on the total weight of the composition.

Like the flavorants, the colorants are also not particularly limited, and may be any food-safe component capable of imparting the desired color to the composition. There are many commercially available food-safe colorants on the market, and those of ordinary skill in the art would be capable of selecting an appropriate colorant or combination of colorants to achieve the desired color for the composition. Some non-limiting examples of suitable colorants include the various available food colorings (whether liquid or gel-based), tricalcium phosphate, paprika oleoresin, etc.

The colorants may be included in the cheese substitute (or analogue) composition in any suitable amount depending on the desired color of the composition. For example, in some embodiments, the colorants may be present in the composition (i.e., either individually or collectively as a combined total amount of all colorants) in an amount of 0 wt % to about 4 wt %, or in a positive amount (i.e., greater than 0 wt %) to about 4 wt % based on the total weight of the composition. In some embodiments, for example, the colorants may be present (i.e., either individually or collectively) in the composition in an amount of about 0.001 wt % to about 4 wt %, about 0.005 wt % to about 4 wt %, about 0.01 wt % to about 4 wt %, about 0.05 wt % to about 4 wt %, about 0.001 wt % to about 2 wt %, or about 0.01 wt % to about 2 wt %. In some embodiments, for example, the colorants may be present collectively in the composition in an amount of 0 wt % to about 4 wt %, about 0.1 wt % to about 4 wt %, about 0.1 wt % to about 3 wt %, or about 0.1 wt % to about 2 wt %. In some embodiments, for example, the colorants may be present collectively in the composition in an amount of about 0.5 wt %, 0.75 wt %, 1 wt %, 1.1 wt %, 1.2 wt %, 1.25 wt %, 1.3 wt % or 1.5 wt % based on the total weight of the composition.

The acidulants are also not particularly limited, and may be any food-safe component capable of imparting the desired acidic taste to the composition. Acidulants provide a sour, zesty or tangy taste (i.e., an acidic taste) to the composition. There are many commercially available food-safe acidulants on the market, and those of ordinary skill in the art would be capable of selecting an appropriate acidulant or combination of acidulants to achieve the desired taste of the composition. Any suitable food-safe acid may be used as an acidulant. Some non-limiting examples of suitable acidulants include citric acid, lactic acid, acetic acid, etc.

The acidulants may be included in the cheese substitute (or analogue) composition in any suitable amount depending on the desired acidic taste of the composition. For example, in some embodiments, the acidulants may be present in the composition (i.e., either individually or collectively as a combined total amount of all acidulants) in an amount of 0 wt % to about 5 wt %, or in a positive amount (i.e., greater than 0 wt %) to about 5 wt % based on the total weight of the composition. In some embodiments, for example, the acidulants may be present (i.e., either individually or collectively) in the composition in an amount of about 0.01 wt % to about 5 wt %, about 0.05 wt % to about 5 wt %, about 0.01 wt % to about 4 wt %, about 0.05 wt % to about 4 wt %, about 0.01 wt % to about 3 wt %, or about 0.05 wt % to about 3 wt %. In some embodiments, for example, the acidulants may be present collectively in the composition in an amount of 0 wt % to about 5 wt %, about 0.1 wt % to about 5 wt %, about 0.1 wt % to about 3 wt %, or about 0.1 wt % to about 2 wt %. In some embodiments, for example, the acidulants may be present collectively in the composition in an amount of about 0.05 wt %, 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, or 0.75 wt % based on the total weight of the composition.

The pH adjusters are also not particularly limited, and may be any food-safe component capable of adjusting the pH of the composition. Also, while the pH adjusters may adjust the pH of the composition to be more acidic, these components are distinct from the acidulants, which provide the composition with the desired level of sour, zesty or tangy taste (i.e., an acidic taste). In contrast, while the pH adjusters may change the pH of the composition, this modification typically does not affect the taste of the composition, or does not affect the taste in the same way the acidulants do.

There are many commercially available food-safe pH adjusters on the market, and those of ordinary skill in the art would be capable of selecting an appropriate pH adjuster or combination of pH adjusters to achieve the desired pH of the composition. Any suitable food-safe pH adjuster may be used. Some non-limiting examples of suitable such pH adjusters include salts having a monovalent or divalent metal cation, and a suitable anion. As would be understood, these salt-based pH adjusters operate by dissociation in the water in the composition. The monovalent or divalent metal cation of the salt may include any suitable such metal cation, for example, any monovalent or divalent alkali metal ion or alkali earth metal ion. In some embodiments, for example, the metal cation may include Na⁺, K⁺, Mg²⁺ and/or Ca²⁺. The anion of the salt may be any anion capable of forming a salt with the monovalent or divalent cation. For example, the anion may be any food-safe anion, including but not limited to, citrate anions, lactate anions, phosphate anions, sulfate anions, carbonate anions, phosphate anions, etc. Accordingly, some non-limiting examples of suitable pH adjusters include sodium citrate, calcium citrate, potassium citrate, calcium lactate, calcium phosphate, calcium carbonate, etc.

The pH adjuster(s) may be included in the cheese substitute (or analogue) composition in any suitable amount depending on the desired pH of the composition. For example, in some embodiments, the pH adjuster(s) may be present in the composition (i.e., either individually or collectively as a combined total amount of all pH adjusters) in an amount of 0 wt % to about 2 wt %, or in a positive amount (i.e., greater than 0 wt %) to about 2 wt % based on the total weight of the composition. In some embodiments, for example, the pH adjusters may be present (i.e., either individually or collectively) in the composition in an amount of about 0.05 wt % to about 2 wt %, about 0.05 wt % to about 1 wt %, about 0.1 wt % to about 2 wt %, or about 0.1 wt % to about 1 wt %. In some embodiments, for example, the pH adjusters may be present collectively in the composition in an amount of 0 wt % to about 2 wt %, about 0 wt % to about 1 wt %, about 0.1 wt % to about 2 wt %, about or about 0.1 wt % to about 1 wt %. In some embodiments, for example, the pH adjusters may be present collectively in the composition in an amount of about 0.05 wt %, 0.1 wt %, 0.15 wt %, 0.2 wt %, 0.25 wt %, or 0.3 wt % based on the total weight of the composition.

The humectants are also not particularly limited, and may be any food-safe component capable of imparting the desired moisture content or moisture retention properties to the composition. As would be understood by those of ordinary skill in the art, humectants are hygroscopic components. In the presently disclosed compositions, the humectants bind the moisture in the compositions as well as absorb moisture in the ambient air. As such, including one or more humectants in the presently disclosed compositions provides control over the moisture content and/or moisture retention properties of the compositions.

There are many commercially available food-safe humectants on the market, and those of ordinary skill in the art would be capable of selecting an appropriate humectant or combination of humectants to achieve the desired moisture control, content and/or retention of the composition. Any suitable food-safe humectants may be used, some non-limiting examples of which include glycerin, honey, salt (i.e., sodium chloride), sugar, sugar alcohols, glucose syrup, etc.

The humectants may be included in the cheese substitute (or analogue) composition in any suitable amount depending on the desired moisture control, content and/or retention properties of the composition. For example, in some embodiments, the humectant(s) may be present in the composition (i.e., either individually or collectively as a combined total amount of all humectants) in an amount of 0 wt % to about 10 wt %, or in a positive amount (i.e., greater than 0 wt %) to about 10 wt % based on the total weight of the composition. In some embodiments, for example, the humectants may be present (i.e., either individually or collectively) in the composition in an amount of 0 wt % to about 6 wt %, 0 wt % to about 5 wt %, greater than 0 wt % to about 6 wt %, greater than 0 wt % to about 5 wt %, about 0.01 wt % to about 6 wt %, or about 0.01 wt % to about 5 wt %. In some embodiments, for example, the humectants may be present collectively in the composition in an amount of 0 wt % to about 3 wt %, 0 wt % to about 2 wt %, about 0 wt % to about 1 wt %, greater than 0 wt % to about 3 wt %, greater than 0 wt % to about 2 wt %, or greater than 0 wt % to about 1 wt %. In some embodiments, for example, the humectants may be omitted (i.e., 0 wt %), or may be present collectively in the composition in an amount of about 0.5 wt %, 1 wt %, 1.5 wt %, 2 wt %, 2.5 wt % or 3 wt % based on the total weight of the composition.

The cheese substitute (or analogue) compositions according to embodiments of the present disclosure may further include any of a variety of dietary additives for improving the nutrition or, e.g., the digestive impact of the composition. These types of dietary additives are well known to those of ordinary skill in the art, and are therefore, not described in detail here. However, by way of example, one such additive might include fiber (or dietary fiber). This fiber (or dietary fiber) can be provided in any suitable form and be sourced from any suitable source. Some non-limiting examples of suitable fiber (or dietary fiber) sources include psyllium (or psyllium husk) and sugar cane. However, as noted above, many sources of dietary fiber are known, and any of these sources may also be used in the presently disclosed compositions without limitation.

The dietary additives (e.g., fiber) may be included in the cheese substitute (or analogue) composition in any suitable amount depending on the desired nutritional properties or other physiological (e.g., digestive) impact of the composition. For example, in some embodiments, the dietary additive(s) may be present in the composition (i.e., either individually or collectively as a combined total amount of all dietary additives) in an amount of 0 wt % to about 5 wt %, or in a positive amount (i.e., greater than 0 wt %) to about 5 wt % based on the total weight of the composition. In some embodiments, for example, the dietary additive(s) may be present (i.e., either individually or collectively) in the composition in an amount of 0 wt % to about 4 wt %, 0 wt % to about 3 wt %, greater than 0 wt % to about 4 wt %, greater than 0 wt % to about 3 wt %, about 0.01 wt % to about 5 wt %, about 0.01 wt % to about 4 wt %, about 0.01 wt % to about 3 wt %, about 1 wt % to about 5 wt %, about 1 wt % to about 4 wt %, or about 1 wt % to about 3 wt %. In some embodiments, for example, the dietary additives may be present collectively in the composition in an amount of 0 wt % to about 4 wt %, 0 wt % to about 3 wt %, about 0 wt % to about 2 wt %, greater than 0 wt % to about 4 wt %, greater than 0 wt % to about 3 wt %, greater than 0 wt % to about 2 wt %, about 0.5 wt % to about 2 wt %, or about 0.5 wt % to about 1.5 wt %. In some embodiments, for example, the dietary additives may be omitted (i.e., 0 wt %), or may be present collectively in the composition in an amount of about 0.5 wt %, 1 wt %, 1.5 wt %, 2 wt %, 2.5 wt % or 3 wt % based on the total weight of the composition.

As discussed herein, the cheese substitute (or analogue) compositions according to embodiments of the present disclosure can imitate or replicate various different types or styles of cheese (or natural cheese). For example, in some embodiments, the disclosed compositions may imitate natural cheddar cheese, natural mozzarella cheese or natural American cheese, though it is understood that the present disclosure is not limited to these types or styles of cheese. As would be understood by those of ordinary skill in the art, different types of natural cheeses have different chemical and physical qualities or characteristics that may require different additives or different combinations of additives to imitate or replicate in the substantially dairy-free (or completely dairy-free) compositions according to embodiments of the present disclosure. For example, to imitate certain types or styles of cheese (for example, but not limited to American cheese), the compositions may further include one or more emulsifiers, and/or one or more other structural and/or functional additives.

The emulsifier(s) are not particularly limited, and may be any food-safe component capable of emulsifying the components of the composition. Suitable food-safe emulsifiers are known to those of ordinary skill in the art, and are commercially available. Those of ordinary skill in the art would be capable of selecting an appropriate emulsifier or combination of emulsifiers to achieve the desired emulsification of the composition. Any suitable food-safe emulsifier(s) may be used, some non-limiting examples of which include mono- and di-glycerides, stearoyl lactylates, sorbitan esters, polyglycerol esters, sucrose esters, lecithin, etc.

The emulsifier(s) may be included in the cheese substitute (or analogue) composition in any suitable amount depending on the desired emulsification. For example, in some embodiments, the emulsifier(s) may be present in the composition (i.e., either individually or collectively as a combined total amount of all emulsifiers) in an amount of 0 wt % to about 4 wt %, or in a positive amount (i.e., greater than 0 wt %) to about 4 wt % based on the total weight of the composition. In some embodiments, for example, the emulsifiers may be present (i.e., either individually or collectively) in the composition in an amount of 0 wt % to about 3 wt %, 0 wt % to about 2 wt %, greater than 0 wt % to about 3 wt %, greater than 0 wt % to about 2 wt %, about 0.1 wt % to about 3 wt %, or about 0.1 wt % to about 2 wt %. In some embodiments, for example, the emulsifiers may be present collectively in the composition in an amount of 0 wt % to about 3 wt %, 0 wt % to about 2 wt %, about 0 wt % to about 1 wt %, greater than 0 wt % to about 3 wt %, greater than 0 wt % to about 2 wt %, or greater than 0 wt % to about 1 wt %. In some embodiments, for example, the emulsifiers may be omitted (i.e., 0 wt %), or may be present collectively in the composition in an amount of about 0.1 wt %, 0.2 wt %, 0.3 wt %, 0.4 wt %, 0.5 wt %, 0.6 wt %, 0.7 wt %, 0.8 wt %, 0.9 wt % or 1 wt % based on the total weight of the composition.

The other structural and/or functional additives in the cheese analogue (or cheese substitute) composition are also not particularly limited, and may be any suitable food-safe additives designed or configured to impart the desired structural and/or functional characteristic to the composition. Additionally, as discussed above in connection with the additives, the other structural and/or functional additives may each individually be added separately to the composition, or each may individually be provided as part of the dry ingredient mixture. Some non-limiting examples of suitable such structural or functional additives include hydrocolloids and polysaccharides. Suitable food-safe structural and/or functional additives (e.g., hydrocolloids and polysaccharides) are known to those of ordinary skill in the art, and are commercially available. Those of ordinary skill in the art would be capable of selecting an appropriate structural and/or functional additive or combination of such additives to achieve the desired structural and/or functional characteristics (e.g., hardness and/or coagulation) of the cheese analogue (or cheese substitute) composition.

As would be understood by those of ordinary skill in the art, hydrocolloids are a class of compounds widely used in the development of specific food structures. Hydrocolloids are water-soluble polymers that contribute viscosity and gelation in food systems. And while many hydrocolloids are polysaccharides, not all polysaccharides are hydrocolloids since many insoluble polysaccharides (such as cellulose), do not interact with water (a function of hydrocolloids). Some common (and non-limiting) hydrocolloids include certain milk, egg, and vegetable-derived protein isolates, as well as gelatin. Hydrocolloids may also be extracted and refined or semi-refined and added to food compositions to impart a certain structure or functionality (e.g., viscosity, gelation). Some non-limiting examples of suitable hydrocolloids and polysaccharides for use as additives in embodiments of the present disclosure include: plant-based compounds such as pectin, modified starches, modified cellulose, guar gum, locust bean gum, and konjac mannan; extrudate gums such as gum Arabic, gum ghatii, and tragacanth; and seaweed-derived ingredients such as agar, alginates, and carrageenan.

The structural and/or functional additive(s) may be included in the cheese substitute (or analogue) composition in any suitable amount depending on the desired structural and/or functional properties (e.g., hardness and/or coagulation). For example, in some embodiments, the structural and/or functional additive(s) may be present in the composition (i.e., either individually or collectively as a combined total amount of all structural and/or functional additive(s)) in an amount of 0 wt % to about 5 wt %, or in a positive amount (i.e., greater than 0 wt %) to about 5 wt % based on the total weight of the composition. In some embodiments, for example, the structural and/or functional additive(s) may be present (i.e., either individually or collectively) in the composition in an amount of 0 wt % to about 4 wt %, 0 wt % to about 3 wt %, greater than 0 wt % to about 4 wt %, greater than 0 wt % to about 2 wt %, about 0.1 wt % to about 3 wt %, or about 0.1 wt % to about 2 wt %. In some embodiments, for example, the structural and/or functional additives may be present collectively in the composition in an amount of 0 wt % to about 4 wt %, 0 wt % to about 3 wt %, about 0 wt % to about 2 wt %, 0 wt % to about 1 wt %, greater than 0 wt % to about 4 wt %, greater than 0 wt % to about 3 wt %, greater than 0 wt % to about 2 wt %, or greater than 0 wt % to about 1 wt %. In some embodiments, for example, the structural and/or functional additives may be omitted (i.e., 0 wt %), or may be present collectively in the composition in an amount of about 0.1 wt %, 0.2 wt %, 0.3 wt %, 0.4 wt %, 0.5 wt %, 0.6 wt %, 0.7 wt %, 0.8 wt %, 0.9 wt % or 1 wt % based on the total weight of the composition.

As can be seen in some of the above additive descriptions, certain components may be used as more than one type of additive. For example, sugar and salt in the composition may function as both flavorants and humectants. When such multi-purpose components serve more than one purpose in the compositions, they can be provided in the same amount as a single purpose component (e.g., in the amounts listed above for the flavorant or the humectant). Alternatively, in some embodiments, these multi-purpose components may be provided in the sum of amounts for both of the listed single purpose components (e.g., in the amount listed above for the flavorant added to the amount listed above for the humectant).

According to embodiments of the present disclosure, the components described above may be mixed together to form the cheese substitute (or analogue) composition. Depending on the proportions of the components of the composition, the final moisture content of the compositions may vary some. And while the final moisture content of the composition is not particularly limited, the moisture content may affect certain properties of the resulting cheese substitute (or analogue) composition. For example, the moisture content may affect the shredding, slicing or melting properties of the cheese, as well as the texture (e.g., hardness and/or chew). As different types or styles of natural cheese intended to be imitated by the cheese substitute (or analogue) compositions may require different such properties (i.e., slicing, shredding, melting or texture properties), the moisture content of the cheese substitute (or analogue) composition may vary depending on the natural product intended for imitation. In some embodiments, however, the moisture content of the final cheese substitute (or analogue) composition may be about 40 wt % to about 60 wt %, for example, about 45 wt % to about 60 wt %, or about 45 wt % to about 55 wt %.

The cheese substitute (or analogue) compositions according to embodiments of the present disclosure may be used to make any type or style of cheese, as discussed herein above. Additionally, the compositions according to embodiments of the present disclosure may be manufactured into various different shapes or forms, without limitation, e.g., shreds, slices, and blocks. The compositions according to embodiments of the present disclosure may also be used in any cooking or food application or recipe that calls for melting cheese, for example as bases for sauces (e.g., mornay and the like), or as a base for a cheese-based condiment (e.g., pourable cheese dips) which may or may not include added condiments (e.g., chiles, etc.).

In embodiments of the compositions in which the cheese substitute (or analogue) compositions are packaged as shreds, the shreds may be mixed or coated with an anti-caking agent to prevent or minimize coagulation or “sticking” of the shreds after packaging and during storage. Anti-caking agents for this purpose (e.g., for use with natural cheese shreds) are well known and a wide variety of these components are commercially available. As such, those of ordinary skill in the art are capable of selecting an appropriate anti-caking agent or combination of anti-caking agents, and an appropriate amount of the anti-caking agent(s). Some non-limiting examples of suitable anti-caking agents include cellulose, potato starch, corn starch, etc. And in some embodiments, the anti-caking agent may be added to the shreds in an amount of 0.1 wt % to about 2 wt %, or about 0.1 wt % to about 1 wt %, for example, about 0.1 wt % to about 0.5 wt %.

The cheese analogue (or substitute) compositions according to embodiments of the present disclosure exhibit improved physical and chemical properties and characteristics compared to conventional cheese analogue (or substitute) compositions. For example, the cheese analogue (or substitute) compositions according to embodiments of the present disclosure exhibit generally uniform melt characteristics, and generally melt and spread upon melting in a manner similar to natural cheese. As such, in some embodiments, the cheese analogue (or substitute) compositions disclosed herein emulate the melt characteristics of natural cheese. For example, while many conventional cheese analogue compositions maintain “shred definition” after melting, the cheese analogue (or substitute) compositions according to embodiments of the present disclosure achieve a uniform melt that emulates the melt and spread achieved by the corresponding natural cheese (i.e., the natural cheese intended to be mimicked by the cheese analogue (or substitute) composition). As used herein, the term “shred definition” refers to the maintenance of distinct shreds of the cheese analogue composition after melting, while the term “uniform melt” refers to the melting and spreading of the composition to form a generally uniform surface of the cheese analogue composition after melt in which no (or substantially no) shreds can be observed. This “shred definition” is demonstrated, for example, in the left side of the pizza shown in FIG. 5, in which the melted cheese maintains distinctly visible or identifiable shreds, and not a uniform surface after melting.

The method of making the cheese substitute (or analogue) compositions is not particularly limited. Indeed, the components of the composition (as described herein above) may be combined or mixed in any order using any suitable mixing or combination technique. In some embodiments, the method may include mixing the fat source, the starch source and/or the protein source (or the dry ingredient mixture), the leavening agent, and the water source to form a composition mixture, and heating the composition mixture to form the cheese analogue or cheese substitute composition. The heating of the composition mixture is not particularly limited, and the composition mixture may be heated to any temperature suitable to cause the composition mixture to form a cheese-like solid, or cheese-like “curds.” For example, in some embodiments, the composition mixture may be heated to a temperature of about 150° F. to about 190° F. And in some embodiments, the composition mixture may be heated in stages, for example, in a first stage to a temperature of about 150° F. to about 155° F., in a second stage to a temperature of about 160° F. to about 180° F., and in a third stage to a temperature of about 190° F. The cheese-like curds or solids may be formed in to a block, matured or dried, and then further processed as desired (e.g., sliced or shredded, and packaged).

For example, in some embodiments, the method may include mixing the water source and the fat source to form a first precursor mixture, and heating the first precursor mixture. The dry ingredient mixture may then be added to the first precursor mixture to form a second precursor mixture, which second precursor mixture may be heated. And the method may further include adding the leavening agent to the second precursor mixture to form a composition mixture, which composition mixture may be heated to the temperature noted above. In some embodiments, for example, the method of making the cheese substitute (or analogue) compositions may include adding the water and the fat (or lipid) source to a vessel (e.g., a cheese cooker), and maintaining the temperature of the mixture of water and fat (or lipid) source at about 110° F. to about 120° F. The water and fat (or lipid) source may be added to the vessel in any manner or order so long as the result is a liquid phase in the vessel. For example, in some embodiments, the water may be added first to the vessel, and the fat (or lipid) source may be first melted and then added to the water in the vessel. However, if is understood that the fat (or lipid) source does not need to be melted prior to addition to the vessel. Instead, in some embodiments, the fat (or lipid) source may be added first to the vessel, melted (typically at a temperature of about 130° F. to about 150° F.), and then diluted and cooled with water until the resulting liquid phase reaches a temperature of about 110° F. to about 120° F.

The dry ingredients (with the exception of the leavening agent) may then be added to the mixture. The dry ingredients include those ingredients (other than the leavening agent) that are provided in dry or powder form (and which may make up the dry ingredient mixture), and may include the starch source and those additives that are provided in dry (or powder) form, e.g., certain proteins, certain flavorants, colorants, acidulants, pH adjusters, structural and/or functional additives, emulsifiers and dietary additives. The dry ingredients may be added to the mixture in any manner, without limitation. In some embodiments, however, the dry ingredients may be pre-blended to ensure more uniform or homogeneous distribution within the water/fat source mixture.

After addition of the dry ingredients, the mixture is stirred or mixed and cooked to a temperature of about 150° F. to about 155° F. When the dry ingredient/fat source/water mixture reaches temperature, any liquid additives (e.g., the humectant(s) and certain flavorants) may then be added to the mixture while stirring or mixing. The resulting mixture may then be cooked to a temperature of about 165° F. to about 180° F.

The leavening agent may then be added to the mixture. The leavening agent may be added in the form of a dry powder, or as a slurry in which the leavening agent is first suspended or dispersed in water, and the slurry added to the mixture in the vessel while stirring or mixing. When the leavening agent is provided in the form of a slurry, the ratio of leavening agent to water in the slurry is not particularly limited, and may be any suitable ratio. In some embodiments, for example, the ratio of leavening agent to water in the slurry is about 1:1 to about 1:5.

At this stage, the oil (which is liquid) may be added to the vessel while stirring or mixing, and the resulting mixture may be cooked to about 190° F. When the mixture reaches this temperature, the mixture may continue to be mixed for a sufficient amount of time to achieve “curd” formation, e.g., about 2-5 minutes, or about 3 minutes. The resulting composition may form a block similar to a block of natural cheese, which may then be allowed to cool, and then packaged and stored. This block of analogue cheese may be converted to the desired shape, size or form (e.g., shreds or slices) after allowing the block to come to an equilibrium in texture.

It is understood that the present disclosure is not limited to the order of component addition described in the above example embodiment. Indeed, the components of the cheese substitute (or analogue) composition may be added to the vessel and cooked in any suitable order and manner. For example, in some embodiments, the fat (or lipid) source may be melted in the vessel, and high pressure steam may be used to apply sufficient shear force to the melted fat to break the fat down into smaller globules while adding the water and maintaining the temperature below 110° F. The method may then be completed as described above from the addition of the dry ingredients.

In an alternative example, the method may include mixing the fat source with the dry ingredients (e.g., the dry ingredient mixture) to form a first precursor mixture, adding the water source to the first precursor mixture to form a second precursor mixture, and heating the second precursor mixture. The method may further include adding the leavening agent to the second precursor mixture to form the composition mixture, which may be heated as described above. For example, in such an alternative, instead of first mixing the water with the melted fat (or lipid) source in the vessel, the dry ingredients may be directly added to the melted fat (or lipid) source in the vessel while stirring or mixing, followed by addition of the water while stirring or mixing, and maintaining the temperature of the resulting mixture at about 110° F. The method may then be completed as described above from the addition of the liquid additives. In some embodiments, the mixture of melted fat source, dry ingredients and water may be mixed for a period of time (e.g., about 1 to about 5 minutes) prior to addition of the liquid additives and completion of the method. However, in other embodiments, the liquid additives may be added relatively immediately after addition of the water, e.g., with continuous stirring or mixing.

Additionally, while the above methods include adding the leavening agent to the mixture separately from the remaining dry ingredients, this is not necessary. Indeed, in some embodiments, the leavening agent may be added together with the dry ingredients, e.g., either pre-blended with the other dry ingredients, or added simultaneously or concurrently with the dry ingredients (though not necessarily pre-blended). And in some embodiments, the leavening agent may be added after the dry ingredients. For example, in some embodiments, the method may include mixing the water source and the fat source to form a first precursor mixture, and heating the first precursor mixture, followed by adding the dry ingredient mixture and the leavening agent to the first precursor mixture to form the composition mixture. In such embodiments, the leavening agent may be pre-mixed with the dry ingredient mixture, or may be added simultaneously with the dry ingredient mixture. And in some alternative embodiments, the method may include mixing the dry ingredient mixture and the leavening agent with the fat source to form a first precursor mixture, and adding the water source to the first precursor mixture to form the composition mixture, which may be heated as discussed above.

### EXAMPLES

The following examples are provided for illustrative purposes only, and do not limit the scope of the embodiments of the present disclosure.

In the Examples, the leavening agent used was a chemical leavening agent including a mixture of 42 wt % monocalcium phosphate, 33 wt % sodium bicarbonate, 11 wt % corn starch, 7 wt % palm oil, and 7 wt % palmitic acid.

Also, in the examples, the weight percentages of each component of the various compositions are rounded (either up or down) to either the second or third decimal place. This rounding may cause the total weight percentage of the various compositions reported in the Tables to appear somewhat more or somewhat less than 100 wt %.

However, this phenomenon is due to the rounding up or down of the various weight percentages, and each of the compositions does in fact add up to 100 wt %.

### Examples 1 and 2: Cheddar Cheese

Cheese substitute compositions intended to imitate natural cheddar cheese were prepared using the components at the weight percentages noted in Table 1, below.

TABLE 1

| | Example 1 | Example 2 |
|---|---|---|
| Component | (wt %) | (wt %) |
| Water | 44.13 | 43.82 |
| Coconut Oil | 23.50 | 23.34 |
| Potato Starch | 21.11 | 20.97 |
| Potato Protein | 1.59 | 1.58 |
| Leavening Agent | 1.00 | 1.00 |
| Calcium Phosphate | 1.30 | 1.30 |
| Yellow Colorant | 0.007 | 0.01 |
| Annatto | 0.050 | 0.05 |
| Sea Salt | 1.15 | 1.50 |
| Lactic Acid | 0.12 | 0.30 |
| Sodium Citrate | 0.11 | 0.11 |
| Citric Acid | 0.14 | 0.15 |
| Natural Flavors | 1.79 | 1.87 |
| Glycerin (liq) | 1.00 | 1.00 |
| Canola oil | 3.00 | 3.00 |

In each of Examples 1 and 2, first, the coconut oil was melted and added to a cheese cooker. The coconut oil was maintained at a temperature of about 110° F. to about 120° F. The water was then added while stirring, and the temperature of the coconut oil/water mixture was maintained at a temperature of about 110° F. to about 120° F.

The dry ingredients other than the leavening agent (i.e., potato starch, potato protein, calcium phosphate, yellow colorant, annatto, sea salt, lactic acid, sodium citrate, citric acid, and dry natural flavors) were pre-blended to form a generally uniform mixture. The mixture was then added to the vessel. The resulting mixture was then stirred while cooking to a temperature of about 150° F. to about 155° F. When the mixture reached temperature, the liquid additives denoted (liq) in Table 1 (i.e., glycerin, and liquid natural flavors) were then added to the vessel while stirring, and the resulting mixture was cooked to a temperature of about 165° F. to about 180° F.

The leavening agent was then mixed with water in a 1:1 ratio to form a slurry, and the slurry was added to the vessel while stirring.

After addition of the leavening agent, the canola oil was added to the vessel while stirring, and the resulting mixture was cooked to about 190° F. When the mixture reached temperature, stirring continued for about 3 minutes. The resulting composition was allowed to cool, thus completing the cheddar cheese substitute composition.

### Example 3: American Cheese

A cheese substitute compositions intended to imitate natural American cheese was prepared according to the method described in Example 1, except that the components and weight percentages noted in Table 2, below, were used instead of the components and weight percentages noted in Table 1.

TABLE 2

| Component | Weight Percentage |
|---|---|
| Water | 47.00 |
| Coconut Oil | 20.00 |
| Plant-based modified starch | 1.35 |
| refined from sago | |
| Tapioca Starch | 1.67 |
| Modified potato starch (OSA) | 6.00 |
| Oxidized potato starch | 7.00 |
| Leavening Agent | 0.50 |
| Potato Starch | 1.00 |
| Sugar Cane Fiber | 1.00 |
| Carrageenan | 0.50 |
| Xanthan Gum | 0.30 |
| Calcium phosphate | 1.30 |
| Yellow Colorant | 0.025 |
| Sea Salt | 1.80 |
| Sugar | 1.80 |
| Natural Flavors | 1.905 |
| Sodium Citrate | 0.30 |
| Citric Acid | 0.25 |
| Lactic Acid | 0.05 |
| Glycerin (liq) | 1.00 |
| Canola oil | 5.00 |
| Lecithin (liq) | 0.20 |
| Paprika Oleoresin (liq) | 0.050 |

### Examples 4 and 5: Mozzarella Cheese

A cheese substitute composition intended to imitate natural mozzarella cheese was prepared according to the method described in Example 1, except that the components and weight percentages noted in Table 3, below, were used instead of the components and weight percentages noted in Table 1.

TABLE 3

| | Example 4 | Example 5 |
|---|---|---|
| Component | (wt %) | (wt %) |
| Water | 43.00 | 42.95 |
| Coconut oil | 20.00 | 20.00 |
| Potato Starch | 23.25 | 23.25 |
| Potato Protein | 1.75 | 1.75 |
| Leavening Agent | 1.00 | 1.00 |
| Calcium phosphate | 1.20 | 1.20 |
| Yellow Colorant | 0.005 | 0.005 |
| Sugar | 1.00 | 1.15 |
| Sea Salt | 2.15 | 2.00 |
| Lactic Acid | 0.20 | 0.20 |
| Sodium Citrate | 0.29 | 0.29 |
| Citric Acid | 0.25 | 0.25 |
| Natural Flavors | 1.90 | 1.95 |
| Glycerin (liq) | 1.00 | 1.00 |
| Canola oil | 3.00 | 3.00 |

### Example 6: Mozzarella Cheese

A cheese substitute composition intended to imitate natural mozzarella cheese was prepared according to the method described in Example 1, except that the components and weight percentages noted in Table 4, below, were used instead of the components and weight percentages noted in Table 1.

TABLE 4

| Component | Weight Percentage |
|---|---|
| Water | 43.32 |
| Coconut oil | 23.34 |
| Potato Starch | 21.00 |
| Potato Protein | 1.55 |
| Leavening Agent | 1.00 |
| Calcium phosphate | 1.30 |
| Yellow Colorant | 0.005 |
| Sea Salt | 1.80 |
| Lactic Acid | 0.30 |
| Sodium Citrate | 0.19 |
| Citric Acid | 0.25 |
| Natural Flavors | 1.95 |
| Glycerin (liq) | 1.00 |
| Canola oil | 3.00 |

### Examples 7-13: Mozzarella Cheese

Cheese substitute compositions intended to imitate natural mozzarella cheese were prepared according to the method described in Example 1, except that the components and weight percentages noted in Table 5, below, were used instead of the components and weight percentages noted in Table 1.

TABLE 5

| | Ex. 7 | Ex. 8 | Ex. 9 | Ex. 10 | Ex. 11 | Ex. 12 | Ex. 13 |
|---|---|---|---|---|---|---|---|
| Component | (wt %) | (wt %) | (wt %) | (wt %) | (wt %) | (wt %) | (wt %) |
| Water | 45.00 | 45.00 | 44.55 | 43.91 | 43.84 | 46.53 | 46.53 |
| Coconut oil | 25.00 | 25.00 | 20.00 | 18.00 | 20.00 | 17.82 | 17.82 |
| Potato Starch | 20.88 | 0.00 | 24.18 | 22.81 | 23.36 | 22.19 | 22.19 |
| Potato Protein | 1.57 | 2.00 | 1.82 | 1.19 | 1.76 | 1.67 | 1.67 |
| Leavening Agent | 0.10 | 0.10 | 1.00 | 1.20 | 0.60 | 0.59 | 0.59 |
| Calcium | 1.00 | 1.00 | 1.00 | 1.15 | 1.50 | 1.29 | 1.29 |
| phosphate | | | | | | | |
| Yellow Colorant | 0.002 | 0.002 | 0.003 | 0.005 | 0.002 | 0.00 | 0.002 |
| Sugar | 1.00 | 1.00 | 1.00 | 1.00 | 1.00 | 1.98 | 1.98 |
| Sea Salt | 1.60 | 1.60 | 1.60 | 1.60 | 2.15 | 1.98 | 1.98 |
| Lactic Acid | 0.05 | 0.05 | 0.05 | 0.20 | 0.45 | 0.10 | 0.10 |
| Sodium Citrate | 0.30 | 0.30 | 0.30 | 0.30 | 0.30 | 0.30 | 0.30 |
| Citric Acid | 0.25 | 0.25 | 0.25 | 0.25 | 0.25 | 0.40 | 0.40 |
| Natural Flavors | 0.25 | 0.25 | 0.25 | 1.38 | 1.78 | 2.19 | 2.19 |
| Glycerin (liq) | 0.00 | 0.00 | 0.00 | 1.00 | 1.00 | 0.99 | 0.99 |
| Canola oil | 3.00 | 3.00 | 4.00 | 0.00 | 2.00 | 1.98 | 1.98 |
| Modified potato | 0.00 | 15.45 | 0.00 | 0.00 | 0.00 | 0.00 | 0.00 |
| starch (OSA) | | | | | | | |
| Fava bean protein | 0.00 | 5.00 | 0.00 | 0.00 | 0.00 | 0.00 | 0.00 |
| Palm Stearin | 0.00 | 0.00 | 0.00 | 6.00 | 0.00 | 0.00 | 0.00 |

To assess the effect of an anti-caking agent, freezing or refrigerating on the performance of cheese substitute compositions according to embodiments of the present disclosure, the mozzarella cheese substitute composition according to Example 4 was used to make three pizzas. These three pizzas were cooked, prepared and/or stored in different manners in order to assess the performance of the cheese substitute compositions under different conditions. The same pizza dough and pizza sauce were used to make all three pizzas, and the mozzarella cheese substitute composition according to Example 4 was shredded and used to top all three pizzas. The proportions of dough, sauce and cheese substitute composition were the same for all three pizzas, and all three pizzas were baked in the same deck oven.

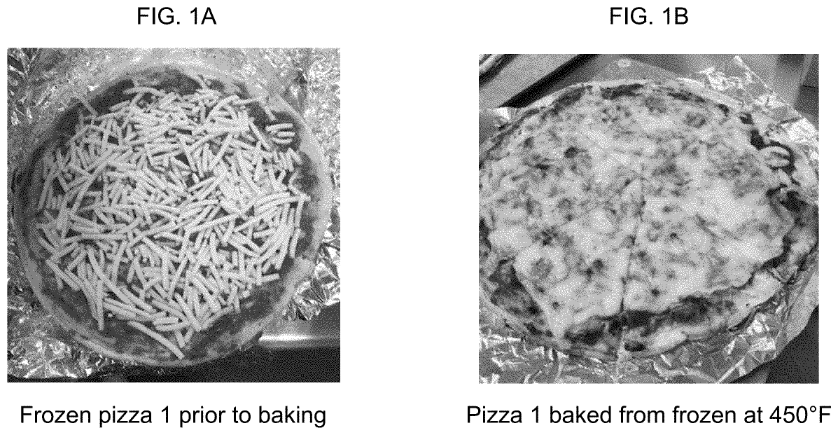

Pizza 1: The cheese substitute composition according to Example 4 was shredded and tossed with 0.4 wt % cellulose (as an anti-caking agent). The cellulose coated shreds were then used to top a simple pizza (i.e., pizza dough topped with sauce, and then topped with the shreds). The pizza was pre-made and stored in the freezer for 2 days before baking. The frozen pizza was baked in the deck oven at 450° F. for about 11-12 minutes without first thawing the pizza. FIG. 1A is a photograph of the frozen pizza just prior to baking, and FIG. 1B is a photograph of the pizza after baking. As shown in FIG. 1B, the shreds of the composition of Example 4 were not affected by freezing or the addition of cellulose, and the shreds melted and formed bubbles during baking in a manner very similar to (or even indistinguishable from) natural cheese. Additionally, freezing the pizza prior to baking had no effect on the melting of the cheese substitute composition shreds.

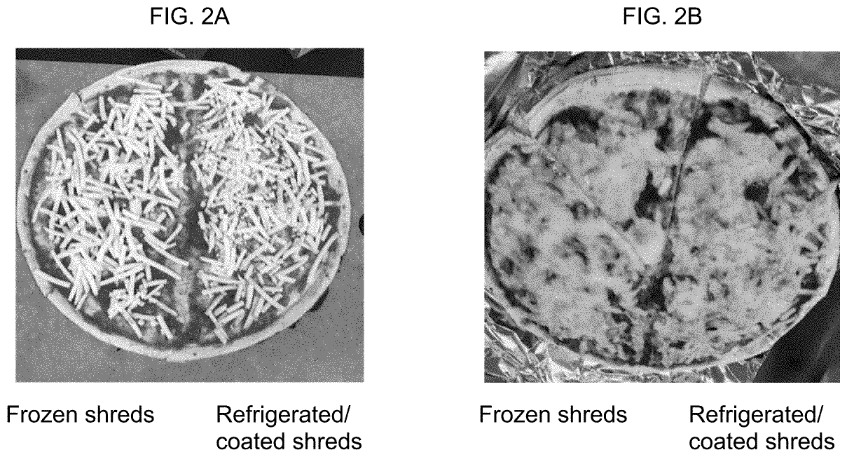

Pizza 2: The cheese substitute composition according to Example 4 was shredded and tossed with 0.4 wt % cellulose (as an anti-caking agent). These coated shreds were stored in the refrigerator (i.e., at approximately 40° F.) prior to use. The refrigerated, coated shreds were used to top half of the pizza. The other half of the pizza was topped with shreds that were frozen and not coated. The pizza (with the frozen shreds on one half, and the refrigerated and coated shreds on the other half) was made fresh just prior to baking at 450° F. for 11-12 minutes in the deck oven. FIG. 2A is a photograph of pizza 2 just prior to baking, and FIG. 2B is a photograph of pizza 2 after baking. As shown in FIG. 2A, the refrigerated and coated shreds were slightly more fragile than the frozen shreds. However, as shown in FIG. 2B, both shreds melted similarly to natural cheese, though the frozen shreds melted slightly better than the refrigerated, coated shreds.

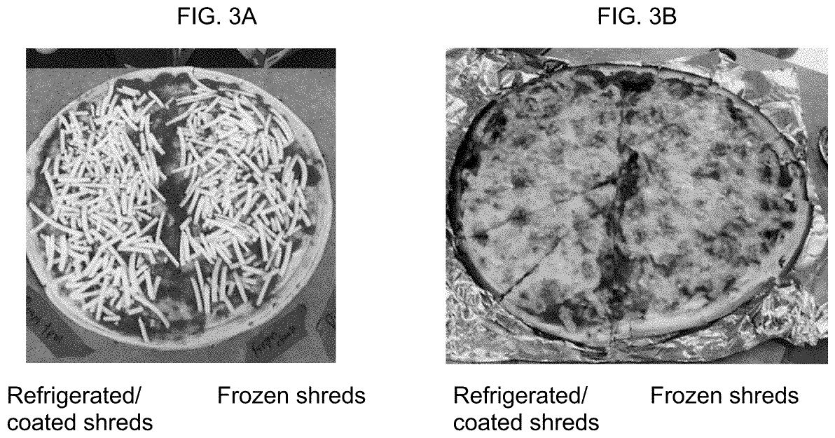

Pizza 3: The pizza was prepared as in pizza 2, i.e., with one half topped with frozen shreds, and the other half topped with refrigerated and coated shreds. The pizza was made fresh just prior to baking at 750° F. for about 6 minutes in the deck oven. FIG. 3A is a photograph of pizza 3 just prior to baking, and FIG. 3B is a photograph of pizza 3 after baking. During baking, the shreds on both halves of the pizza melted in about 4 minutes, and the pizza was allowed to cook for an additional 2 minutes to assess whether the shreds would develop browning or “burnt” spots characteristic of certain natural mozzarella or “pizza” cheeses. As shown in FIG. 3B, the shreds on both halves of the pizza melted equally well, and the shreds did develop the browning or “burnt” spots (though portions of the edges of the pizza crust began to burn before these brown spots appeared). Additionally, baking the pizza at this high temperature demonstrated that the melted shreds exhibited good stretch when pulled.

As can be seen from the performance of the shreds in pizzas 1-3 above, freezing the shreds did not break the shreds did not have any effect on the melting properties. Freezing the pre-made pizza (i.e., topped with the shreds prior to freezing) also did not have any effect on the melting properties. Also, while the addition of an anti-caking agent (here, cellulose) at 0.4% slightly reduced melting when baked at low temperature (450° F.), this difference in melting was not observed when baked at high temperature (750° F.). However, as shown in the melt of pizza 1 (i.e., the pre-made, frozen pizza including shreds coated with cellulose), coating the shreds with the anti-caking agent (here, cellulose) at the same level (0.4%) and then freezing them did not reduce the melting upon baking. Accordingly, the cheese substitute compositions according to embodiments of the present disclosure can be frozen either with or without cellulose without affecting the melting properties. While the cellulose did slightly reduce melting when the coated shreds were used at a refrigerated temperature (i.e., approximately 40° F.), the observed difference was minimal and only observed at a low temperature bake (i.e., 450° F.). At higher temperature bakes, the refrigerated and coated shreds melted equally as well as the frozen shreds.

Additionally, to assess the performance of the cheese substitute compositions according to embodiments of the present disclosure compared to the performance of natural cheese, the cheddar cheese substitute composition according to Example 2, and the mozzarella cheese substitute composition according to Example 4 were used to make pizzas 4 and 5, respectively. To compare the performance of these cheese substitute compositions with their natural cheese counterparts, each pizza was topped on one half with the cheese substitute composition (i.e., Example 2 on the first half of pizza 4, and Example 4 on the first half of pizza 5), and topped on the other half with the natural cheese counterpart (i.e., a dairy cheddar cheese on the second half of pizza 4, and natural mozzarella on the second half of pizza 5). These pizzas were prepared fresh, just prior to baking in a deck oven at 450° F. for 11-12 minutes. The same pizza dough and pizza sauce were used to make both pizzas, and the proportions of dough, sauce and cheese substitute composition or natural cheese were the same for all pizza halves.

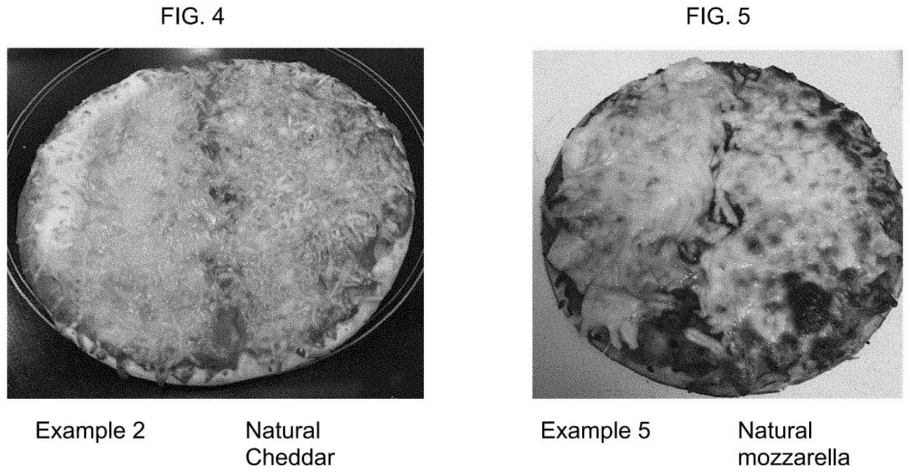

FIG. 4 is a photograph of pizza 4 (comparing natural cheddar cheese to the cheddar cheese substitute composition of Example 2) after baking. As shown in FIG. 4, the shreds of the cheddar cheese substitute composition of Example 2 melted similarly (and almost indistinguishably) to the natural cheddar cheese.

FIG. 5 is a photograph of pizza 5 (comparing natural mozzarella cheese to the mozzarella cheese substitute composition of Example 5) after baking. As shown in FIG. 5, the shreds of the mozzarella cheese substitute composition of Example 5 melted similarly to the natural mozzarella cheese.

Further, to assess the effect of the leavening agent on the performance of the cheese substitute compositions according to embodiments of the present disclosure, the mozzarella cheese substitute composition according to Example 5 but without the leavening agent, and the mozzarella cheese substitute composition according to Example 5 (with the leavening agent) were used to make pizza 6. And the mozzarella cheese substitute composition according to Example 5 but without the leavening agent, and natural mozzarella cheese were used to make pizza 7. Specifically, pizza 6 was topped on one half with the mozzarella cheese substitute composition according to Example 5 but without the leavening agent, and topped on the other half with the mozzarella cheese substitute composition according to Example 3 (with the leavening agent). And pizza 7 was topped on one half with the mozzarella cheese substitute composition according to Example 5 but without the leavening agent, and topped on the other half with natural mozzarella cheese. These pizzas were prepared fresh, just prior to baking in a deck oven at 450° F. for 11-12 minutes. The same pizza dough and pizza sauce were used to make both pizzas, and the proportions of dough, sauce and cheese substitute composition or natural cheese were the same for all pizza halves.

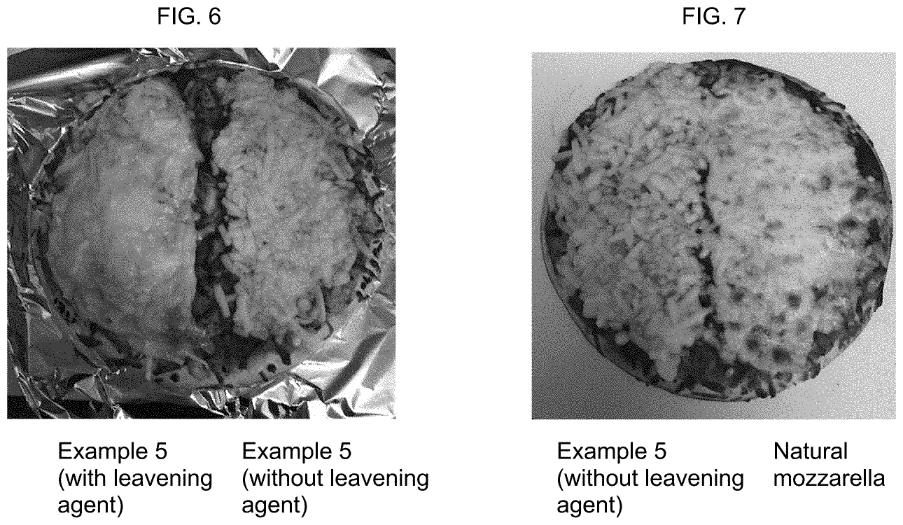

FIG. 6 is a photograph of pizza 6 (comparing the Example 5 shreds without the leavening agent to the Example 5 shreds with the leavening agent) after baking. As shown in FIG. 6, the shreds of the mozzarella cheese substitute composition of Example 5 without the leavening agent did not melt as completely as the shreds of the Example 5 composition including the leavening agent. Instead, as can be seen in the photograph, many of the shreds in the Example 5 composition without the leavening agent remain shredded in appearance, and not melted. In contrast, the Example 5 composition with the leavening agent melted completely, and very similarly to natural mozzarella cheese (as can be seen by comparing FIG. 6 and FIG. 7).

FIG. 7 is a photograph of pizza 7 (comparing the Example 5 shreds without the leavening agent to natural mozzarella cheese) after baking. As shown in FIG. 7, the shreds of the mozzarella cheese substitute composition of Example 5 without the leavening agent did not melt as completely as the natural mozzarella cheese. Instead, as can be seen in the photograph, many of the shreds in the Example 5 composition without the leavening agent remain shredded in appearance, and not melted. As such, this composition (without the leavening agent) does not imitate the natural mozzarella cheese as well as the composition including the leavening agent.

While certain exemplary embodiments of the present disclosure have been illustrated and described, those of ordinary skill in the art will recognize that various changes and modifications can be made to the described embodiments without departing from the spirit and scope of the present invention, and equivalents thereof, as defined in the claims that follow this description. For example, although certain components may have been described in the singular, i.e., “a” protein source, “a” starch source, and the like, one or more of these components in any combination can be used according to the present disclosure.

Also, although certain embodiments have been described as “comprising” or “including” the specified components, embodiments “consisting essentially of” or “consisting of” the listed components are also within the scope of this disclosure. For example, while embodiments of the present invention are described as including a composition comprising a starch and/or protein source, a fat source, sodium bicarbonate, an oil, optional additives, and water, compositions consisting essentially of or consisting of these components is also within the scope of this disclosure. Accordingly, the compositions may consist essentially of the starch and/or protein source, fat source, sodium bicarbonate, oil, optional additives, and water. In this context, “consisting essentially of” means that any additional components in the composition will not materially interfere with, or significantly affect, the performance (e.g., the melting properties) of the cheese substitute composition.

As used herein, unless otherwise expressly specified, all numbers such as those expressing values, ranges, amounts or percentages may be read as if prefaced by the word “about,” even if the term does not expressly appear. Further, the word “about” is used as a term of approximation, and not as a term of degree, and reflects the penumbra of variation associated with measurement, significant figures, and interchangeability, all as understood by a person having ordinary skill in the art to which this disclosure pertains. Any numerical range recited herein is intended to include all sub-ranges subsumed therein. Plural encompasses singular and vice versa. For example, while the present disclosure describes “a” starch source or “a” protein source, a mixture of such starch sources or protein sources can be used. When ranges are given, any endpoints of those ranges and/or numbers within those ranges can be combined within the scope of the present disclosure. The terms “including” and like terms mean “including but not limited to,” unless specified to the contrary.

Notwithstanding that the numerical ranges and parameters set forth herein may be approximations, numerical values set forth in the Examples are reported as precisely as is practical. Any numerical value, however, inherently contains certain errors necessarily resulting from the standard variation found in their respective testing measurements. The word “comprising” and variations thereof as used in this description and in the claims do not limit the disclosure to exclude any variants or additions.

What is claimed is:

1. A cheese analogue or cheese substitute composition, comprising:
a fat source;
a dry ingredient mixture comprising a starch source and/or a protein source;
a leavening agent; and
a water source.

2. The cheese analogue or cheese substitute composition according to claim 1, further comprising one or more additives.

3. The cheese analogue or cheese substitute composition according to claim 2, wherein the one or more additives comprises one or more acidulants, flavor additives emulsifying salts, pH adjusters, colorants, dietary additives, and/or humectants.

4. The cheese analogue or cheese substitute composition according to claim 1, wherein the dry ingredient mixture further comprises one or more additives.

5. The cheese analogue or cheese substitute composition according to claim 4, wherein the one or more additives comprises one or more acidulants, flavor additives emulsifying salts, pH adjusters, colorants, dietary additives, and/or humectants.

6. The cheese analogue or cheese substitute composition according to claim 1, wherein the leavening agent comprises a chemical leavening agent.

7. The cheese analogue composition or cheese substitute composition according to claim 6, wherein the chemical leavening agent comprises sodium bicarbonate.

8. The cheese analogue or cheese substitute composition according to claim 6, wherein the chemical leavening agent comprises baking soda and/or baking powder.

9. The cheese analogue or cheese substitute composition according to claim 8, wherein the baking soda and/or the baking powder is encapsulated.

10. The cheese analogue or cheese substitute composition according to claim 1, wherein the leavening agent is present in the composition in an amount of greater than 0 wt % to about 5 wt % based on a total weight of the cheese analogue or cheese substitute composition.

11. The cheese analogue or cheese substitute composition according to claim 1, wherein the fat source comprises a plant-based fat source, and/or the protein source comprises a plant-based protein source, and/or the starch source comprises a plant-based starch source.

12. The cheese analogue or cheese substitute composition according to claim 1, wherein the cheese analogue or cheese substitute composition is vegetarian or vegan.

13. A method of making the cheese analogue or cheese substitute composition of claim 1, the method comprising:
mixing the fat source, the dry ingredient mixture, the leavening agent, and the water source to form a composition mixture; and
heating the composition mixture to form curds.

14. The method according to claim 13, wherein the heating the mixture comprises heating the composition mixture to a temperature of about 150° F. to about 190° F.

15. The method according to claim 13, wherein the heating the composition mixture comprises:
a first heating of the composition mixture to a temperature of about 150° F. to 155° F.;
a second heating of the composition mixture to a temperature of about 160° F. to about 180° F.; and
a third heating of the composition mixture to a temperature of about 190° F.

16. The method according to claim 13, wherein the mixing comprises:
mixing the water source and the fat source to form a first precursor mixture, and heating the first precursor mixture;
adding the dry ingredient mixture to the first precursor mixture to form a second precursor mixture, and heating the second precursor mixture; and
adding the leavening agent to the second precursor mixture to form the composition mixture.

17. The method according to claim 13, wherein the mixing comprises:
mixing the dry ingredient mixture with the fat source to form a first precursor mixture;
adding the water source to the first precursor mixture to form a second precursor mixture, and heating the second precursor mixture; and
adding the leavening agent to the second precursor mixture to form the composition mixture.

18. The method according to claim 13, wherein the mixing comprises:
mixing the water source and the fat source to form a first precursor mixture, and heating the first precursor mixture;
adding the dry ingredient mixture and the leavening agent to the first precursor mixture to form the composition mixture.

19. The method according to claim 13, wherein the mixing comprises:
mixing the dry ingredient mixture and the leavening agent with the fat source to form a first precursor mixture; and
adding the water source to the first precursor mixture to form the composition mixture.

20. The method according to claim 13, wherein the mixing comprises:
mixing the water source and the dry ingredient mixture to form a first precursor mixture, and heating the first precursor mixture;
adding the leavening agent to the first precursor mixture to form a second precursor mixture, and
adding the fat source to the second precursor mixture and optionally heating the second precursor mixture to form the composition mixture.
